(19) United States
(12) Patent Application Publication
(10) Pub. No.: US 2022/0312723 A1
(43) Pub. Date: Oct. 6, 2022

(54) AMMONIA MITIGATION IN ANIMAL LITTER COMPOSITIONS

(71) Applicant: Church & Dwight Co., Inc., Princeton, NJ (US)

(72) Inventor: Robert T. Zehr, Somerset, NJ (US)

(73) Assignee: Church & Dwight Co., Inc., Princeton, NJ (US)

(21) Appl. No.: 17/219,347

(22) Filed: Mar. 31, 2021

(51) Int. Cl. A01K 1/015

(52) U.S. Cl. CPC A01K 1/0154; A01K 1/0155

(57) ABSTRACT

The present disclosure provides methods for preparing animal litter composition and, in particular, methods of improving odor control in such animal litter compositions. The methods may include providing an animal litter composition that includes a manganese salt, the manganese salt being effective to react with odor-causing ammonia compounds that come into contact with the animal litter composition to thereby reduce an amount of ammonia gas released from a surface of the animal litter composition. In particular, in some embodiments, the present disclosure provides animal litter composition with improved odor control, such compositions including a plurality of particles, at least a portion of which include a liquid absorbing material, and a manganese salt at least partially coating at least a portion of the plurality particles.

### FIELD OF THE DISCLOSURE

The present disclosure relates to methods and compositions for minimizing ammonia generation in animal litters and, in particular, animal litter compositions providing ammonia mitigation therein.

### BACKGROUND

Generally, metal salts are used in a variety of industrial and/or commercial settings and the characteristics associated with many metal salts can vary. For example, metal salts may be used in products of manufacture and other applications. In particular, metal or metallic salts are commonly used due to their high sorption characteristics which allow them to interact with and absorb, or adsorb, gaseous ammonia. Some metallic salts are also known to be anti-bacterial and/or urease inhibitors which can provide some odor reduction that is associated with ammonia-based compounds. Such metallic salts are useful in many applications at least based on their ability to absorb or adsorb certain gaseous components that they interact with. For example, metallic salts are employed in applications such as, e.g., refrigeration units and applications (e.g., where ammonia is employed as the refrigerant), liquid fertilizers, infrared detectors and reflective coatings, photo transistors, photo voltaic cells, electroplating applications, and pet litter compositions.

In the context of pet litter compositions, the use of metallic salts can be beneficial in providing odor reduction related to gaseous ammonia formed in the litter compositions. For example, ammonia is one of the main chemical components associated with malodor emanating from litter compositions during use over time. In particular, ammonia is typically formed by the bacterial decomposition (facilitated by the urease enzyme) of urea which is present in cat urine and the urine of other animals. Previous attempts have been made to provide deodorization of pet litters using certain metallic salts, for example, as discussed in U.S. Pat. No. 4,494,481 to Rodriguez et. al., U.S. Pat. No. 6,287,550 to Trinh et. al., and U.S. Pat. No. 7,964,529, each of which are incorporated herein by reference in their entirety. However, there remains a need in the field for providing ammonia mitigation and malodor reduction in animal litter compositions.

### SUMMARY OF THE DISCLOSURE

The present disclosure relates to methods of reducing ammonia generation in liquid absorbing materials (e.g., such as animal litter compositions), and litter compositions having reduced ammonia generation characteristics when compared to other litter compositions that have not been configured according to the present disclosure. Advantageously, some embodiments of the present disclosure relate to animal litter compositions and methods of preparing such compositions that are effective to reduce ammonia generation in the animal litter composition (e.g., to reduce the quantity of ammonia generated in and emanating from the animal litter composition over a period of time).

Some aspects of the present disclosure provide an animal litter composition comprising a plurality of particles of a liquid absorbing material and a manganese salt. For example, the manganese salt may at least partially coat the individual particles of the liquid absorbing material. The type of manganese salt may vary and, in certain embodiments, the manganese salt is manganese chloride. Typically, the manganese salt is present in an amount of at least about 0.005% by dry weight, based on the total dry weight of the coated liquid absorbing material. The type of liquid absorbing material used in the animal litter composition may vary and generally any liquid absorbing material commonly used in pet litters as would be understood by a person skilled in the art would be suitable. In certain embodiments, for example, the liquid-absorbing material may include a clay-based material, a non-clay based material (e.g., such as silica), or a combination thereof. In some embodiments, the liquid absorbing material may comprise a clay-based material selected from the group consisting of bentonite, vermiculite, montmorillonite, smectite, and combinations thereof.

In some embodiments, animal litter compositions as described herein may include one or more additives in addition to the liquid absorbing material and the manganese salt. For example, such additives may be selected from the group consisting of fillers, clumping agents, de-dusting agents, fragrances, bicarbonates, binders, and preservatives. As noted herein, animal litter compositions according to the disclosure can advantageously provide ammonia mitigation (e.g., to reduce ammonia generated from the decomposition of pet urine deposited in the litter). In some embodiments, animal litter compositions as provided herein can be effective to reduce an amount of ammonia gas released from a surface of the animal litter composition by at least about 5% relative to an animal litter of identical composition, but that does not include the manganese salt.

Other aspects of the disclosure provide methods of improving odor control in animal litter compositions. For example, in some embodiments, methods according to the present disclosure may comprise providing the animal litter composition so that it includes a manganese salt, in particular, wherein the presence of the manganese salt is effective to react with ammonia compounds that come into contact with the animal litter composition and thereby reduce an amount of ammonia gas released from a surface of the animal litter composition after the animal litter composition comes into contact with the ammonia compounds. In certain embodiments, for example, the presence of the manganese salt in the animal litter composition is effective to reduce an amount of ammonia gas released from a surface of the animal litter composition by at least about 5% relative to an animal litter of identical composition, but that does not include the manganese salt.

In one or more embodiments of methods as described herein the animal litter composition may be provided as a plurality of particles of a liquid absorbing material. In such embodiments, the particles of the liquid absorbing material are contacted with a content of a solution comprising the manganese salt in an aqueous solvent so that the manganese salt at least partially coats the particles of the liquid absorbing material. Typically, the manganese salt is manganese chloride and the aqueous solvent is water; however, other manganese salts and/or other solvents are possible. In some embodiments, the manganese salt solution may be applied to the plurality of particles at a certain concentration. For example, in some embodiments, the solution may include about 0.1% to about 10% manganese salt by weight, based on the total weight of the solution.

Further aspects of the present disclosure provide methods for preparing animal litter compositions. In some embodiments, for example, a method of preparing an animal litter composition may include combining particles of a liquid absorbing material with a manganese salt such that the manganese salt at least partially coats, individually, at least a portion of the particles of the liquid absorbing material. As noted herein, animal litter compositions according to the disclosure may also include one or more additives therein. For example, in some embodiments, the particles of the liquid absorbing material including the manganese salt may be combined with one or more additives selected from the group consisting of fillers, clumping agents, de-dusting agents, fragrances, bicarbonates, binders, and preservatives.

In one or more embodiments, the manganese salt may be provided as a solution of the manganese salt in an aqueous solvent. Typically, the manganese salt is manganese chloride and the aqueous solvent is water; however, other manganese salts and/or other solvents are possible. In some embodiments, the solution may include about 0.1% to about 10% manganese salt by weight, based on the total weight of the manganese salt solution. In some embodiments, the solution is combined with the particles of the liquid absorbing material in a sufficient amount so that the manganese salt is present in the animal litter composition in an amount of at least about 0.005% by dry weight, based on the total dry weight of the coated liquid absorbing material. Since the manganese salt is provided as a solution (e.g., including an aqueous solvent), in some embodiments, the methods of the disclosure may further comprise drying the animal litter composition after combination of the particles of the liquid absorbing material with the manganese salt solution. For example, to remove any excess moisture therein. As noted herein, the liquid absorbing material typically a clay-based material, a non-clay based material, or a combination thereof. In some embodiments of methods, the manganese salt can be combined with the particles of the liquid absorbing material in a sufficient amount to reduce an amount of ammonia gas released from a surface of the animal litter composition by at least about 5% relative to an animal litter of identical composition, but that does not include the manganese salt.

The present disclosure thus includes, without limitation, the following embodiments:

Embodiment 1: An animal litter composition comprising a plurality of particles, at least a portion of which comprise a liquid absorbing material; and a manganese salt at least partially coating at least a portion of the plurality particles.

Embodiment 2: The animal litter composition of embodiment 1, wherein the manganese salt is manganese chloride.

Embodiment 3: The animal litter composition according to any of embodiments 1-2, wherein the manganese salt is present in an amount of at least about 0.005% by dry weight, based on the total dry weight of the coated liquid absorbing material.

Embodiment 4: The animal litter composition according to any of embodiments 1-3, wherein the liquid-absorbing material comprises a clay-based material, a non-clay based material, or a combination thereof.

Embodiment 5: The animal litter composition of embodiment 4, wherein the clay-based material is selected from the group consisting of bentonite, vermiculite, montmorillonite, smectite, and combinations thereof.

Embodiment 6: The animal litter composition according to any of embodiments 1-5, wherein the animal litter composition further comprises one or more additives selected from the group consisting of fillers, clumping agents, de-dusting agents, fragrances, bicarbonates, binders, and preservatives.

Embodiment 7: The animal litter composition according to any of embodiment 1-6, wherein the animal litter composition is effective to reduce an amount of ammonia gas released from a surface of the animal litter composition by at least about 5% relative to an animal litter of identical composition, but that does not include the manganese salt.

Embodiment 8: A method of improving odor control in an animal litter composition, the method comprising providing the animal litter composition so that it includes a manganese salt, the presence of the manganese salt being effective to react with ammonia compounds that come into contact with the animal litter composition and thereby reduce an amount of ammonia gas released from a surface of the animal litter composition after the animal litter composition comes into contact with the ammonia compounds.

Embodiment 9: The method of embodiment 8, wherein the presence of the manganese salt in the animal litter composition is effective to reduce an amount of ammonia gas released from a surface of the animal litter composition by at least about 5% relative to an animal litter of identical composition, but that does not include the manganese salt.

Embodiment 10: The method according to any of embodiments 8-9, wherein the animal litter composition comprises particles of a liquid absorbing material.

Embodiment 11: The method according to any of embodiments 8-10, wherein the particles of the liquid absorbing material are contacted with a content of a solution comprising the manganese salt in an aqueous solvent so that the manganese salt at least partially coats the particles of the liquid absorbing material.

Embodiment 12: The method according to any of embodiments 8-11, wherein the manganese salt is manganese chloride.

Embodiment 13: The method of embodiment 11, wherein the aqueous solvent is water.

Embodiment 14: The method of embodiment 11, wherein the solution comprises about 0.1% to about 10% manganese salt by weight, based on the total weight of the solution.

Embodiment 15: A method of preparing an animal litter composition, the method comprising combining particles of a liquid absorbing material with a manganese salt such that the manganese salt at least partially coats, individually, at least a portion of the particles of the liquid absorbing material.

Embodiment 16: The method of embodiment 15, further comprising combining the particles of the liquid absorbing material including the manganese salt with one or more additives selected from the group consisting of fillers, clumping agents, de-dusting agents, fragrances, bicarbonates, binders, and preservatives.

Embodiment 17: The method according to any of embodiments 15-16, further comprising drying the animal litter composition after combination of the particles of the liquid absorbing material with the manganese salt.

Embodiment 18: The method according to any of embodiments 15-17, wherein the manganese salt is provided as a solution of the manganese salt in an aqueous solvent.

Embodiment 19: The method according to any of embodiments 15-18, wherein the manganese salt is manganese chloride.

Embodiment 20: The method of embodiment 18, wherein the solution comprises about 0.1% to about 10% manganese salt by weight, based on the total weight of the manganese salt solution.

Embodiment 21: The method of embodiment 18, wherein the solution is combined with the particles of the liquid absorbing material in a sufficient amount so that the manganese salt is present in the animal litter composition in an amount of at least about 0.005% by dry weight, based on the total dry weight of the coated liquid absorbing material.

Embodiment 22: The method according to any of embodiments 15-21, wherein the liquid absorbing material comprises a clay-based material, a non-clay based material, or a combination thereof.

Embodiment 23: The method of embodiment 22, wherein the clay based material is selected from the group consisting of bentonite, vermiculite, montmorillonite, smectite, and combinations thereof.

Embodiment 24: The method according to any of embodiments 15-23, wherein the manganese salt is combined with the particles of the liquid absorbing material in a sufficient amount to reduce an amount of ammonia gas released from a surface of the animal litter composition by at least about 5% relative to an animal litter of identical composition, but that does not include the manganese salt.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE FIGURES

Having thus described the disclosure in general terms, reference will now be made to the accompanying drawings, which are not necessarily drawn to scale, and wherein:

FIG. 1 illustrates a schematic view of experimental setup for measuring the ammonia mitigation efficacy of an animal litter composition, according to an example embodiment of the present disclosure;

FIG. 2 illustrates a plot of the ammonia concentration (in ppm/h) present in a headspace at or above the surface of samples of a treated animal litter composition, according to an example embodiment of the present disclosure;

FIG. 3 illustrates a plot of the ammonia concentration (in ppm/h) present in a headspace at or above the surface of samples of a treated animal litter composition, according to an example embodiments of the present disclosure;

FIG. 4 illustrates a plot of the ammonia concentration (in ppm/h) present in a headspace at or above the surface of samples of a treated animal litter composition, according to an example embodiment of the present disclosure; and

FIG. 5 illustrates a plot of the ammonia concentration (in ppm/h) present in a headspace at or above the surface of animal litter compositions that have been treated with varying concentrations of manganese chloride, according to an example embodiment of the present disclosure.

### DETAILED DESCRIPTION OF THE DISCLOSURE

The present disclosure now will be described more fully hereinafter with reference to specific embodiments. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

The present disclosure relates to animal litter compositions and methods of preparing such compositions. The presently disclosed methods and compositions can be particularly beneficial in that they can provide the ability to reduce or mitigate ammonia generation in liquid absorbing materials and, in particular, in animal litter compositions including such liquid absorbing materials. Advantageously, the animal litter compositions and methods of preparing such compositions as described herein are effective to reduce ammonia generation within the animal litter composition (e.g., to reduce the quantity of ammonia generated in and emanating from the animal litter composition over a period of time).

In one or more embodiments, an animal litter composition according to the present disclosure can comprise at least a plurality of particles of a liquid absorbing material and a metal salt (e.g., such as a manganese salt). In some embodiments, the metal salt may at least partially coat the individual articles of the liquid absorbing material. Optional additional ingredients may also be included as further described herein. A liquid absorbing material for use in an animal litter composition as described herein can include any such material previously recognized as useful in forming animal litters. For example, the liquid absorbing material may be a clay-based material, a non-clay based material, or a combination thereof.

In some embodiments, for example, the liquid absorbing material is a clay-based material. In certain embodiments, the clay-based material may be a naturally clumping clay. For example, a clay soil or comminuted rock containing at least one water swellable clay mineral (such as a montmorillonite or smectite) can be used. In some embodiments, a comminuted bentonite, such as a sodium bentonite, which contains a preponderant amount of montmorillonite clay mineral, may be used as the liquid absorbing material in the present animal litter composition. Non-limiting examples of bentonite clays that can be used include sodium bentonite, potassium bentonite, lithium bentonite, calcium bentonite and magnesium bentonite, or combinations thereof. In other embodiments, the clay-based material may be a non-clumping clay material. Non-limiting examples of useful non-clumping clays include attapulgite, Fuller's earth, calcium bentonite, palygorskite, sepiolite, kaolinite, illite, halloysite, hormite, vermiculite or mixtures thereof. Clay-based liquid absorbing materials (including both clumping and non-clumping clays) useful in the present animal litter compositions are further described in U.S. Pat. No. 8,720,375 to Miller et al., the disclosure of which is incorporated herein by reference.

In some embodiments, the liquid absorbing material may be a non-clay based material. Typically, such non-clay based materials are also water swellable absorbent materials. Non-limiting examples of non-clay based materials that can be used include zeolites, crushed stone (e.g., dolomite and limestone), gypsum, sand, calcite, recycled waste materials, silica, corn cob, wheat, extruded and/or cross-linked starches, ground cellulosic plant materials, wheat straw, sawdust, fly ash, and the like.

In one or more embodiments, the performance of the present animal litter composition can relate to one or more properties of the liquid absorbing material apart from its ability to absorb liquid. In some embodiments, performance can be improved though use of a clay-based material exhibiting a defined particle size range. For example, suitable liquid absorbing materials can be provided with an average particle size of about 0.2 mm to about 5 mm, about 0.3 mm to about 4 mm, or about 0.5 mm to about 3 mm. In some embodiments, the surface area of each particle of the liquid absorbing material may comprise a defined surface area that that has been found to maximize effectiveness of the animal litter composition in exhibiting reduced adhesion to surfaces when the litter is wetted. For example, particles of the liquid absorbing material can have an average surface area that is less than 20 m²/g, less than 15 m²/g, or less than 10 m²/g. In each of the foregoing ranges, it is understood that the particles preferably have a minimum surface area of at least 1 m²/g. In some embodiments, the particles of the liquid absorbing material can have an average surface of about 1 m²/g to about 20 m²/g, about 2 m²/g to about 15 m²/g, or about 3 m²/g to about 10 m²/g. Surface area can be measured utilizing known methods, such as the Brunauer, Emmett, Teller (“BET”) method wherein surface area is calculated using N₂ absorption. The above values, in some embodiments, thus may be referred to as the BET surface area.

The amount of the liquid absorbing material used in the present animal litter composition can vary. For example, the liquid absorbing material can form about 15% by weight to about 99.5% by weight of the composition. In further embodiments, the amount of the liquid absorbing material in the animal litter composition can be about 20% by weight to about 94% by weight, about 25% by weight to about 90% by weight, about 30% by weight to about 80% by weight, or about 35% by weight to about 55% by weight based on the total weight of the composition.

The animal litter composition also includes a metal salt in addition to the individual particles of the liquid absorbing material. In one or more embodiments as described herein, the particles of liquid absorbing material may have been treated with a metal salt solution (e.g., a metal salt in an aqueous solvent) such that the metal salt at least partially coats, individually, at least a portion of the individual particles of the liquid absorbing material after drying. As used herein, a “metal salt” or “metallic salt” refers to its typical meaning in physical chemistry, for example, an ionic compound formed between a metal cation and an anion forming a soluble salt. The types of metal salts suitable for use in the compositions and methods provided herein may vary. For example, a metal salt as used herein typically refers to a soluble salt of a transition metal. Non-limiting examples of metal salts that can be used include barium chloride (BaCl₂), calcium chloride (CaCl₂), copper chloride (CuCl₂), iron chloride (FeCl₃), manganese chloride (MnCl₂), magnesium chloride (MgCl₂), strontium chloride (SrCl₂), zinc chloride (ZnCl₂), sodium bromide (NaBr), copper sulfate (CuSO₄), and zinc sulfate (ZnSO₄). In some embodiments, the metal salt may preferably be a manganese salt, e.g., such as manganese chloride.

In some embodiments, the metal salt may be present in an amount of at least about 0.001% by dry weight, at least about 0.005% by dry weight, at least about 0.01% by dry weight, at least about 0.05% by dry weight, at least about 0.1% by dry weight, at least about 0.5% by dry weight, at least about 1.0% by dry weight, or at least about 2.0% by dry weight, based on the total dry weight of the coated liquid absorbing material. In some embodiments, the metal salt may be present in an amount in the range of about 0.001% to about 2.0% by dry weight, about 0.005% to about 1.5% by dry weight, or about 0.01% to about 1.0% by dry weight, based on the total dry weight of the coated liquid absorbing material.

As noted above, in one or more embodiments, the metal salt may be provided as a solution of the metal salt in an aqueous solvent when combined with the particles of the liquid absorbing material. Typically, the aqueous solvent is water. However, other solvents may be used as would be understood by a person skilled in the art. Generally, when the metal salt is provided as a solution, the concentration of the metal salt within that solution may vary. For example, the metal salt solution may include a concentration of the metal salt of at least about 0.1% by weight, at least about 1% by weight, at least about 2% by weight, at least about 4% by weight, at least about 6% by weight, at least about 8% by weight, or at least about 10% by weight, based on the total weight of the metal salt solution. In some embodiments, the metal salt may include a concentration of the metal salt in the range of about 0.1% to about 20% by weight, about 0.5% to about 15% by weight, or about 1% to about 10% by weight, based on the total weight of the metal solution.

In some embodiments, the animal litter compositions of the present disclosure may comprise at least about 70%, at least about 80%, at least about 90%, at least about 95%, or at least about 99% of the coated liquid absorbing material (i.e., coated at least partially with a metal salt). In certain embodiments, for example, animal litter compositions according to the disclosure may include 100% of the coated liquid absorbing material. In other embodiments, the animal litter composition may include one or more additional components in addition to the coated liquid absorbing material.

In one or more embodiments, for example, the animal litter composition may also include one or more clumping agents, or clump enhancing materials. Description of suitable clumping agents is provided in U.S. Pat. No. 8,720,375 to Miller et al., the disclosure of which is incorporated herein by reference. Useful clumping agents are those materials suitable to promote adhesion of the fine size particles of litter granules to each other as well as adhesion of the particles to form agglomerates when wetted. Preferably, the clumping agent allows the formation of a gelled agglomerate when exposed to a liquid, such as animal urine. A clumping agent may be provided in admixture (e.g., in particle form) with the further particles forming the animal litter. In some embodiments, the clumping agent can be provided as a coating on at least a portion of the other particles forming the animal litter (e.g., as a coating on at least a portion of the liquid absorbing material). Such coatings may be provided by any known method, such as spraying.

Non-limiting examples of materials suitable for use as a clumping agent include naturally occurring polymers (e.g., naturally occurring starches, water soluble polysaccharides, and gums), semisynthetic polymers (e.g., cellulose derivatives, such as carboxymethyl cellulose), and sealants. Exemplary clumping agents include amylopectins, natural gums, and sodium carboxymethylcellulose. The amount of any clumping agent that is present in the animal litter composition can vary based upon the total composition. For example, it can be useful to include a greater amount of clumping agents when a greater amount of non-absorbent fillers is used. In some embodiments, clumping agents can be present in a total amount of 0.1% by weight to about 6% by weight, about 0.2% by weight to about 5.5% by weight, about 0.3% by weight to about 5% by weight, or about 0.5% by weight to about 4% by weight, based on the total weight of the animal litter composition.

In one or more embodiments, the animal litter composition may also include one or more fillers. Fillers suitable for use in the present animal litter compositions can include a variety of materials that can be a non-absorbent, non-soluble substrate, or can be an absorbent substrate. In one or more embodiments, useful fillers can include absorbent substrates, such as non-clumping clays. Non-limiting examples of useful non-clumping clays include attapulgite, Fuller's earth, calcium bentonite, palygorskite, sepiolite, kaolinite, illite, halloysite, hormite, vermiculite or mixtures thereof. Suitable fillers according to the present disclosure also can include a variety of non-absorbent, non-soluble substrates, such as non-clay substances. Such non-clay substances may, in some embodiments, include organic or inorganic absorbants including, but not limited to, soybean meal, soybean hulls, cottonseed meal, cotton seed hulls, canola meal, sunflower seed meal, linseed meal, safflower meal, rolled oats, crimped oats, pulverized oats, oat hulls, reground oat feed, rice bran, rice millfeed, and rice hulls, beet pulp pellets, beet pulp shreds, citrus pulp pellets, barley feed, feed wheat, milo, and ground grain screenings, wheat shorts, what brand, wheat middlings, wheat millrun, alfalfa meal, corn hominy feed, corn cobs, distillers dried grains, malt sprouts, and brewers dried grains. Other non-limiting examples of non-clay materials that can be used as filler include zeolites, crushed stone (e.g., dolomite and limestone), gypsum, sand, calcite, recycled waste materials, silica, corn cob, wheat, extruded and/or cross-linked starches, ground cellulosic plant materials, wheat straw, and the like.

In some embodiments, it can be useful to provide the filler material in a form exhibiting specific characteristics. For example, it can be useful for the filler material to exhibit an average particle size that is approximately the same as the liquid absorbing material particles. In particular, the filler material may exhibit an average particle size that is +/−20%, +/−15%, +/−10%, or +/−5% of the average particle size of the liquid absorbing material particle size. In some embodiments, it likewise can be useful for the filler material to have an average surface area that is approximately the same as the surface area of the liquid absorbing material particles. The above tolerances thus likewise can apply to surface area.

The amount of the filler used in the present animal litter composition can vary. In some embodiments, filler may be expressly excluded (i.e., forming 0% of the litter composition). Preferably, the filler provides the balance of the animal litter composition after all other materials are included. As examples, the animal litter composition can comprise about 0% by weight to about 75% by weight, about 10% by weight to about 70% by weight, about 25% by weight to about 65% by weight, or about 40% by weight to about 60% by weight of the filler, based on the total weight of the animal litter composition.

In addition to the foregoing, one or more further materials may be included in the present animal litter composition. Specifically, any conventional litter additive may be included to the extent that there is no interference with the ability of the litter composition to provide the useful effect of reduced adherence to surfaces when wetted. Non-limiting examples of additional materials that may be used include binders, preservatives, such as biocides (e.g., benzisothiazolinone, methylisothiazolone), de-dusting agents, fragrance, bicarbonates, and combinations thereof. Each of the foregoing materials separately may be included in any amount up to about 5% by weight, up to about 2% by weight, up to about 1% by weight, or up to about 0.5% by weight, such as about 0.01% by weight to about 5% by weight, to about 4% by weight, to about 3% by weight, to about 2% by weight, or to about 1% by weight, based on the total weight of the animal litter composition. Further, it is understood that any one or more of such materials may be expressly excluded from the present animal litter composition.

These particular formulations and combinations of components are not to be construed as limiting and the specific amounts of individual components may vary based on the desired odor control, flow characteristics, permeation depth, and/or other factors. The animal litter compositions described herein may be used for a wide variety of animals and birds, such as cats, dogs, hamsters, gerbils, rabbits, guinea pigs, mice, rats, ferrets, chickens, ducks, geese, parrots, parakeets, canaries, pigeons, and other animals where a scoopable and/or replaceable litter composition may be useful for sanitary purposes or the like. The compositions of this invention are particularly suitable for use as cat litters.

As noted above, the present disclosure also provides methods for improving odor control in animal litter compositions and methods of preparing animal litter compositions having improved odor control. The methods disclosed herein can advantageously provide animal litter compositions having reduced ammonia generation characteristics when compared to other litter compositions that have not been configured according to the present disclosure. For example, the methods disclosed herein can be effective to provide ammonia mitigation in animal litter compositions (e.g., to thereby reduce an amount of ammonia gas released from a surface of the animal litter composition after the animal litter composition comes into contact with the ammonia compounds.). In some embodiments, animal litter compositions prepared according to the methods described herein may be effective to reduce an amount of ammonia gas released from a surface of the animal litter composition by at least about 5%, at least about 10%, at least about 15%, at least about 20%, at least about 25%, at least about 50%, or at least about 75%, relative to an animal litter of identical composition, but that does not include the manganese salt.

In some embodiments, the disclosure provides methods of improving odor control in an animal litter composition by providing an animal litter composition (e.g., including at least a liquid absorbing material as described herein) so that it includes a metal salt (e.g., such as a manganese salt). Advantageously, the presence of the manganese salt in the animal litter composition is effective to react with ammonia compounds that come into contact with the animal litter composition and thereby reduce an amount of ammonia gas released from a surface of the animal litter composition after the animal litter composition comes into contact with the ammonia compounds. In certain embodiments, for example, the presence of the manganese salt in the animal litter composition is effective to reduce an amount of ammonia gas released from a surface of the animal litter composition by at least about 5%, at least about 10%, at least about 15%, at least about 20%, at least about 25%, at least about 50%, or at least about 75%, relative to an animal litter of identical composition, but that does not include the manganese salt.

As noted herein, the animal litter composition may be provided as a plurality of particles of a liquid absorbing material. In such embodiments, the particles of the liquid absorbing material are contacted with a content of a solution comprising the manganese salt in an aqueous solvent so that the manganese salt at least partially coats the particles of the liquid absorbing material. Typically, the manganese salt is manganese chloride and the aqueous solvent is water; however, other manganese salts and/or other solvents are possible. In some embodiments, the manganese salt solution may be applied to the plurality of particles at a certain concentration. For example, as noted above, the solution may include a concentration of the metal salt of at least about 0.1% by weight, at least about 1% by weight, at least about 2% by weight, at least about 4% by weight, at least about 6% by weight, at least about 8% by weight, or at least about 10% by weight, based on the total weight of the metal salt solution. In some embodiments, the metal salt may include a concentration of the metal salt in the range of about 0.1% to about 20% by weight, about 0.5% to about 15% by weight, or about 1% to about 10% by weight, based on the total weight of the metal solution.

In further embodiments, the present disclosure provides methods for preparing animal litter compositions having improved odor control and ammonia mitigation. One method of preparing an animal litter composition according to the disclosure includes combining particles of a liquid absorbing material (e.g., such as a clay-based material, a non-clay based material, or a combination thereof) with a metal salt (e.g., such as a manganese salt) such that the metal salt at least partially coats, individually, at least a portion of the particles of the liquid absorbing material. As noted herein, animal litter compositions according to the disclosure may also include one or more additives therein. For example, in some embodiments, the particles of the liquid absorbing material including the manganese salt may be combined with one or more additives selected from the group consisting of fillers, clumping agents, de-dusting agents, fragrances, bicarbonates, binders, and preservatives.

In one or more embodiments, the manganese salt may be provided as a solution of the manganese salt in an aqueous solvent. As noted herein, the concentration of the manganese salt in the solution may vary (e.g., the solution may include about 0.1% to about 10% manganese salt by weight, based on the total weight of the manganese salt solution). In some embodiments, the solution is combined with the particles of the liquid absorbing material in a sufficient amount so that the manganese salt is present in the animal litter composition in an amount of at least about 0.005% by dry weight, based on the total dry weight of the coated liquid absorbing material. When the manganese salt is applied to the particles of liquid absorbing material as a solution, it may also be necessary to dry the treated liquid absorbing material for a period of time to remove any excess moisture therefrom. The amount of time and/or the temperature of such a drying step may vary and is generally understood to be an amount of time sufficient to remove any excess moisture from the animal litter composition.

### EXPERIMENTAL

Aspects of the present invention are more fully illustrated by the following examples, which are set forth to illustrate certain aspects of the present invention and are not to be construed as limiting thereof.

Example 1

Testing was carried out to analyze the ammonia mitigation efficiency of animal litters that had been treated with different metal salt solutions. The animal litter compositions included 10 g of vermiculite treated with various metal salt solutions. The metal salt solutions tested included barium chloride (BaCl₂), calcium chloride (CaCl₂), copper chloride (CuCl₂), iron chloride (FeCl₃), manganese chloride (MnCl₂), magnesium chloride (MgCl₂), strontium chloride (SrCl₂), zinc chloride (ZnCl₂), sodium bromide (NaBr), copper sulfate (CuSO₄), and zinc sulfate (ZnSO₄)

The animal litter compositions were prepared by spraying 50 g of a metal salt solution (e.g., including a metal salt in solution with water) onto 25 g of vermiculite clay and mixing the treated vermiculite to ensure homogenous application of the salt solution thereon. Separate samples were prepared using a solution of each of the metal salts described herein. The treated vermiculite samples were then dried overnight in a force draft oven set at 54° C. The mass of the vermiculite and the concentration of the deposited salt solution was known to allow for accurate calculation of the amount of metal salt deposited on the vermiculite clay. The concentration of the metal salt solutions was about 20 mM.

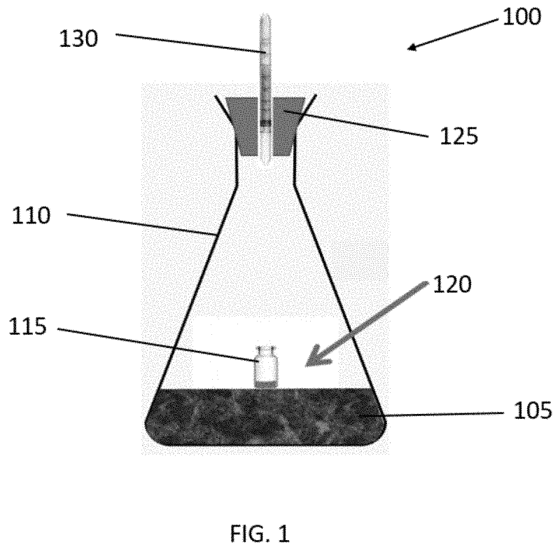

After drying of the treated vermiculite samples, a mass of 10 g of each of the treated vermiculite samples were placed in 250 mL Erlenmeyer flasks. Each flask contained about 0.04 millimoles of the metal salt per gram of vermiculite (e.g., about 0.4 mM metal salt in the 10 g sample). Next, a small vial containing 1 mL of ammonium hydroxide (NH₃OH) was placed on top of the treated vermiculite samples in each Erlenmeyer flask and the flasks were sealed with a one-hole rubber stopper containing a diffusion Drager tube that was sensitive to ammonia (e.g., commercially available from Dragerwerk AG & Co., Lubeck, Germany). A schematic view of the experimental setup (e.g., including a treated vermiculite sample and a vial of ammonium hydroxide within an Erlenmeyer flask having a rubber stopper containing a diffusion Drager tube therein) is provided, for example, in FIG. 1. As shown in FIG. 1, the experimental setup 100 provides a mass of vermiculite 105 that has been treated with a metal salt positioned within a 250 mL Erlenmeyer flask 110. In addition, a vial 115 containing 1 mL of ammonium hydroxide is placed on top of the treated vermiculite 105 such that ammonia vapors generated from the vial 115 are allowed to freely move within a headspace 120 directly above the treated vermiculite 105. Finally, a one-hole rubber stopper 125 is positioned proximate the top portion of the Erlenmeyer flask 110 to seal the opening in the flask. As noted herein, a diffusion Drager tube 130 that is sensitive to ammonia can be positioned in contact with the one-hole rubber stopper 125 to indicate a degree of ammonia exposure within the flask 110.

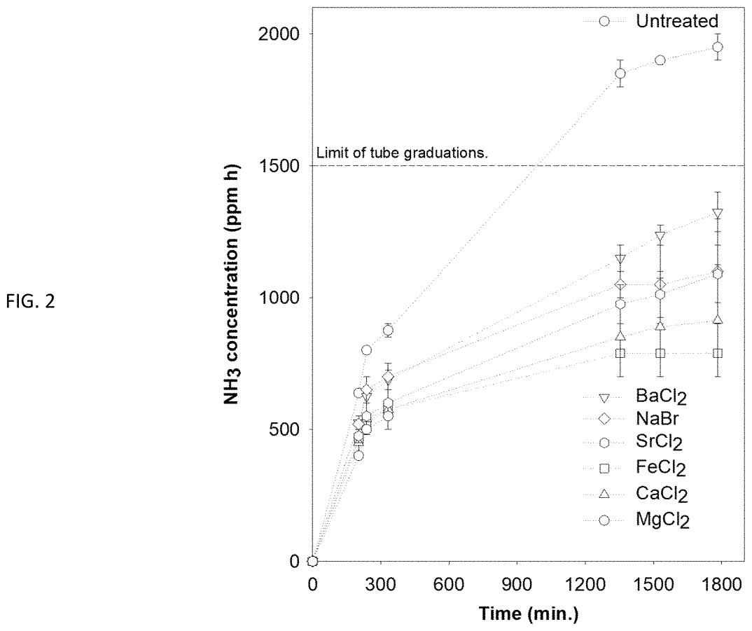

For example, the Drager tubes contained an indicator formula that changes from yellow to violet as the ammonia gas in the Erlenmeyer flask diffuses into the tube and reacts with the indicator material. Calibrated marks along the side of the Drager tube indicated the cumulative ammonia exposure. The extent of the color change was tracked with time and plotted to compare the efficacy of each treated sample. Each treated vermiculite sample was prepared as described herein above and observed in duplicate and the average reading was plotted as a function of elapsed time, for example, as depicted in FIGS. 2-4. In addition, each tested sample was compared to a control sample that consisted of 10 g of vermiculite that was treated with a content of deionized water instead of a metal salt solution. Note that measurements above 1500 ppm/h are extrapolated in the data provided in FIGS. 2-4 because the calibration marks on the Drager tube end at 1500 ppm/h, well before the indicator level. The 1500 ppm/h indicator level is shown in FIGS. 2-4 by a dashed line labelled “Limit of tube graduations.”

FIG. 2 illustrates a plot of the ammonia concentration (in ppm/h) present in a headspace at or above the surface of the samples of treated vermiculite, according to an example embodiment of the present disclosure. As shown in FIG. 2, the first round of samples prepared and tested included vermiculite clay samples treated, individually, with about 0.04 mM/g of vermiculite of one of barium chloride, calcium chloride, iron chloride, magnesium chloride, strontium chloride, or sodium bromate; and a control sample treated with deionized water. As shown in FIG. 2 each of the treated sample demonstrated a significant reduction in the ammonia concentration within the flask when compared to the control sample that was simply treated with deionized water. In particular, the samples treated with iron chloride demonstrated the most significant reduction in ammonia concentration. However, each sample measured in FIG. 2 demonstrated a reduction of ammonia concentration of at least about 50% less than the ammonia concentration in the headspace above the control sample. The representative data from FIG. 2 is presented in Table 1 below. It should be noted that the Drager tube popped out of the stoppers after approximately one night for the MgCl₂ samples resulting in no measurements after the first day. Thus, MgCl₂ samples were tested again during subsequent experiments as detailed herein.

TABLE 1

| | Control | | | | | | |
|---|---|---|---|---|---|---|---|
| Elapsed | (untreated) | BaCl₂ | FeCl₂ | NaBr | CaCl₂ | SrCl₂ | MgCl₂ |
| Time | ppm | ppm | ppm | ppm | ppm | ppm | ppm |
| (Minutes) | Ammonia | Ammonia | Ammonia | Ammonia | Ammonia | Ammonia | Ammonia |
| 0 | 0 | 0 | 0 | 0 | 0 | 0 | 0 |
| 202 | 637.5 | 525 | 465 | 520 | 450 | 475 | 400 |
| 237 | 800 | 625 | 525 | 650 | 540 | 550 | 500 |
| 332 | 875 | 687.5 | 575 | 700 | 575 | 600 | 550 |
| 1354 | 1850 | 1150 | 787.5 | 1050 | 850 | 975 | — |
| 1529 | 1900 | 1237.5 | 787.5 | 1050 | 887.5 | 1012.5 | — |
| 1782 | 1950 | 1325 | 787.5 | 1100 | 912.5 | 1090 | — |

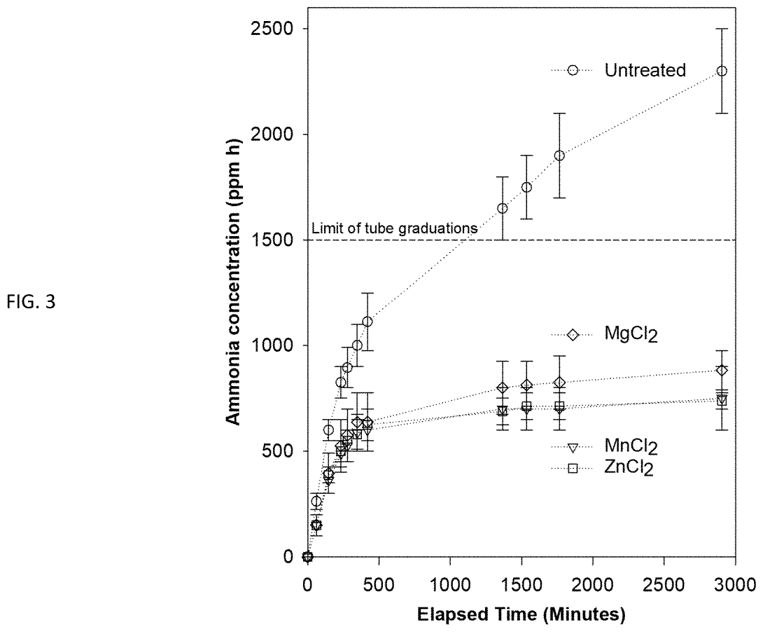

FIG. 3 illustrates a plot of the ammonia concentration (in ppm/h) present in a headspace at or above the surface of samples of a treated animal litter composition, according to an example embodiment of the present disclosure. As shown in FIG. 3, the second round of samples prepared and tested included vermiculite clay samples treated, individually, with about 0.04 mM/g vermiculite of one of magnesium chloride, manganese chloride, or zinc chloride; and a control sample treated with deionized water. Additionally, the second round of samples were tested over longer periods of time (e.g., up to 3 days) and periodic measurements were taken from the Drager tube. As shown in FIG. 3 each of the treated samples demonstrated a significant reduction in the ammonia concentration within the flask when compared to the control sample that was simply treated with deionized water. In particular, the samples treated with manganese and zinc chloride demonstrated the most significant reduction in ammonia concentration over time. However, each sample measured in FIG. 3 demonstrated a reduction of the ammonia concentration in the headspace at or above the surface of the treated vermiculite sample of at least about 50% after 1 day, and at least 75% after 2 or more days, when compared to the ammonia concentration in the headspace at or above the surface of the control sample. The representative data from FIG. 3 is presented in Table 2 below.

TABLE 2

| | Control | | | |
|---|---|---|---|---|
| Elapsed | (untreated) | MnCl₂ | ZnCl₂ | MgCl₂ |
| Time | ppm | ppm | ppm | ppm |
| (Minutes) | Ammonia | Ammonia | Ammonia | Ammonia |
| 0 | 0 | 0 | 0 | 0 |
| 61 | 262.5 | 150 | 150 | 150 |
| 147 | 600 | 362.5 | 387.5 | 395 |
| 233 | 825 | 487.5 | 500 | 525 |
| 278 | 895 | 525 | 550 | 575 |
| 348 | 1000 | 587.5 | 580 | 637.5 |
| 419 | 1112.5 | 600 | 625 | 637.5 |
| 1366 | 1650 | 700 | 687.5 | 800 |
| 1536 | 1750 | 700 | 712.5 | 812.5 |
| 1766 | 1900 | 700 | 712.5 | 825 |
| 2905 | 2300 | 750 | 737.5 | 882.5 |

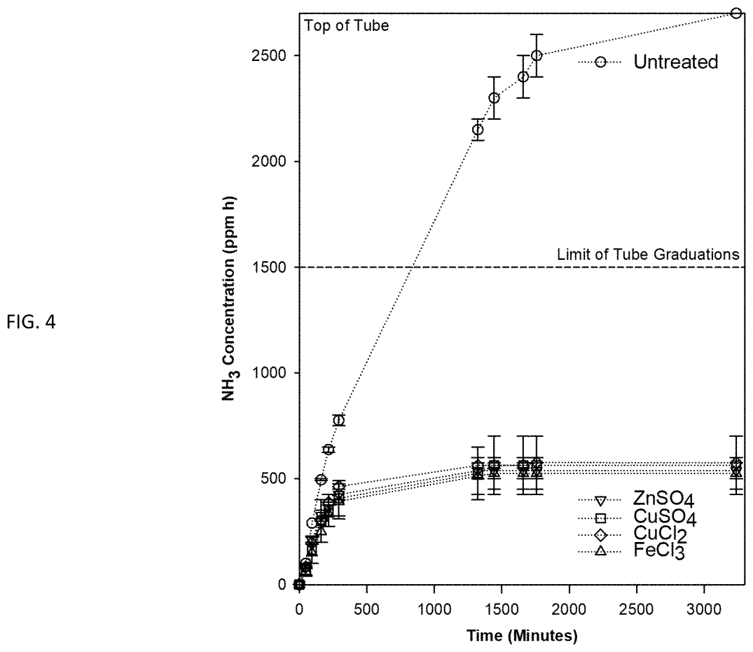

FIG. 4 illustrates a plot of the ammonia concentration (in ppm/h) present in a headspace at or above the surface of samples of a treated animal litter composition, according to an example embodiment of the present disclosure. As shown in FIG. 4, the third round of samples prepared and tested included vermiculite clay samples treated, individually, with about 0.04 mM/g vermiculite of one of zinc sulfate, copper sulfate, copper chloride, or iron chloride; and a control sample treated with deionized water. Likewise, the third round of samples were tested over longer periods of time (e.g., up to 3 days) and periodic measurements were taken from the Drager tube. As shown in FIG. 4 each of the treated samples demonstrated a significant reduction in the ammonia concentration within the flask when compared to the control sample that was simply treated with deionized water. In particular, the samples treated with iron chloride once again demonstrated the most significant reduction in ammonia concentration over time. However, each sample measured in FIG. 4 demonstrated a reduction of the ammonia concentration in the headspace at or above the surface of the treated vermiculite sample of at least about 50% after 1 day, and at least about 75% after 2 or more days, when compared to the ammonia concentration in the headspace at or above the surface of the control sample. The representative data from FIG. 4 is presented in Table 3 below.

TABLE 3

| | Control | | | | |
|---|---|---|---|---|---|
| Elapsed | (untreated) | ZnSO₄ | CuSO₄ | CuCl₂ | FeCl₃ |
| Time | ppm | ppm | ppm | ppm | ppm |
| (Minutes) | Ammonia | Ammonia | Ammonia | Ammonia | Ammonia |
| 0 | 0 | 0 | 0 | 0 | 0 |
| 48 | 100 | 82.5 | 70 | 82.5 | 62.5 |
| 93 | 290 | 207.5 | 165 | 195 | 150 |
| 161 | 495 | 325 | 300 | 305 | 250 |
| 216 | 637.5 | 362.5 | 350 | 387.5 | 332.5 |
| 292 | 775 | 425 | 407.5 | 462.5 | 392.5 |
| 1322 | 2150 | 537.5 | 525 | 562.5 | 512.5 |
| 1443 | 2300 | 537.5 | 562.5 | 562.5 | 525 |
| 1659 | 2400 | 537.5 | 562.5 | 562.5 | 525 |
| 1758 | 2500 | 537.5 | 562.5 | 576 | 525 |
| 3237 | 2700 | 537.5 | 562.5 | 575 | 525 |

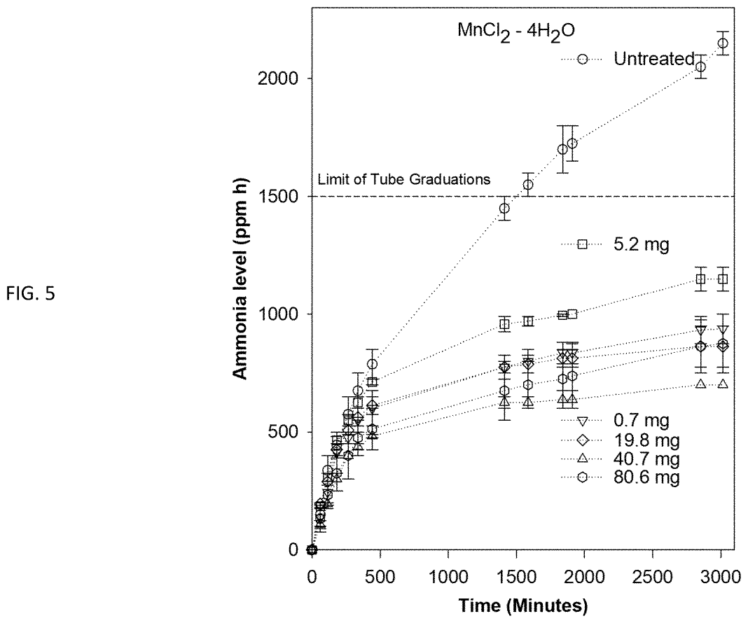

FIG. 5 illustrates a plot of the ammonia concentration (in ppm/h) present in a headspace at or above the surface of animal litter compositions that have been treated with varying concentrations of manganese chloride, according to an example embodiment of the present disclosure. As shown in FIG. 5, the fourth round of samples prepared and tested included vermiculite clay samples treated, individually, with varying concentrations of a manganese salt solution (e.g., including 0.7 mg, 5.2 mg, 19.8 mg, 40.7 mg, and 80.6 mg of the manganese salt solution); and a control sample treated with deionized water. Likewise, the third round of samples were tested over longer periods of time (e.g., up to 3 days) and periodic measurements were taken from the Drager tube. As shown in FIG. 5 each of the treated samples demonstrated a significant reduction in the ammonia concentration within the flask when compared to the control sample that was simply treated with deionized water. In particular, the samples treated with 40.7 mg and 80.6 mg of the manganese salt solution, respectively, demonstrated the most significant reduction in ammonia concentration over time. However, each sample measured in FIG. 5 demonstrated a reduction of the ammonia concentration in the headspace at or above the surface of the treated vermiculite sample of at least about 25% after 1 day, and at least about 50% after 2 or more days, when compared to the ammonia concentration in the headspace at or above the surface of the control sample. The representative data from FIG. 5 is presented in Table 4 below.

TABLE 4

| | Control | 0.7 mg | 5.2 mg | 19.8 mg | 40.7 mg | 80.6 mg |
|---|---|---|---|---|---|---|
| | (untreated) | MnCl₂ | MnCl₂ | MnCl₂ | MnCl₂ | MnCl₂ |
| Elapsed | ppm | ppm | ppm | ppm | ppm | ppm |
| Time | Am- | Am- | Am- | Am- | Am- | Am- |
| (Minutes) | monia | monia | monia | monia | monia | monia |
| 0 | 0 | 0 | 0 | 0 | 0 | 0 |
| 61 | 150 | 137.5 | 185 | 195 | 107.5 | 132.5 |
| 114 | 337.5 | 245 | 307.5 | 290 | 195 | 232.5 |
| 182 | 445 | 412.5 | 465 | 425 | 300 | 325 |
| 265 | 575 | 475 | 550 | 507.5 | 400 | 400 |
| 337 | 675 | 550 | 625 | 562.5 | 437.5 | 475 |
| 442 | 787.5 | 600 | 712.5 | 612.5 | 482.5 | 512.5 |
| 1412 | 1450 | 775 | 957.5 | 775 | 625 | 675 |
| 1586 | 1550 | 800 | 970 | 787.5 | 625 | 700 |
| 1839 | 1700 | 835 | 995 | 812.5 | 637.5 | 725 |
| 1910 | 1725 | 835 | 1000 | 812.5 | 637.5 | 737.5 |
| 2852 | 2050 | 932.5 | 1150 | 862.5 | 700 | 862.5 |
| 3015 | 2150 | 937.5 | 1150 | 862.5 | 700 | 875 |

Many modifications and other embodiments of the disclosure set forth herein will come to mind to one skilled in the art to which these disclosures pertain having the benefit of the teachings presented in the foregoing descriptions. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An animal litter composition comprising:
a plurality of particles, at least a portion of which comprise a liquid absorbing material; and
a manganese salt at least partially coating at least a portion of the plurality particles.

2. The animal litter composition of claim 1, wherein the manganese salt is manganese chloride.

3. The animal litter composition of claim 1, wherein the manganese salt is present in an amount of at least about 0.005% by dry weight, based on the total dry weight of the coated liquid absorbing material.

4. The animal litter composition of claim 1, wherein the liquid-absorbing material comprises a clay-based material, a non-clay based material, or a combination thereof.

5. The animal litter composition of claim 1, wherein the animal litter composition further comprises one or more additives selected from the group consisting of fillers, clumping agents, de-dusting agents, fragrances, bicarbonates, binders, and preservatives.

6. The animal litter composition of claim 1, wherein the animal litter composition is effective to reduce an amount of ammonia gas released from a surface of the animal litter composition by at least about 5% relative to an animal litter of identical composition, but that does not include the manganese salt.

7. A method of improving odor control in an animal litter composition, the method comprising providing the animal litter composition so that it includes a manganese salt, the presence of the manganese salt being effective to react with ammonia compounds that come into contact with the animal litter composition and thereby reduce an amount of ammonia gas released from a surface of the animal litter composition after the animal litter composition comes into contact with the ammonia compounds.

8. The method of claim 7, wherein the presence of the manganese salt in the animal litter composition is effective to reduce an amount of ammonia gas released from a surface of the animal litter composition by at least about 5% relative to an animal litter of identical composition, but that does not include the manganese salt.

9. The method of claim 7, wherein the animal litter composition comprises particles of a liquid absorbing material.

10. The method of claim 9, wherein the particles of the liquid absorbing material are contacted with a content of a solution comprising the manganese salt in an aqueous solvent so that the manganese salt at least partially coats the particles of the liquid absorbing material.

11. The method of claim 10, wherein the solution comprises about 0.1% to about 10% manganese salt by weight, based on the total weight of the solution.

12. A method of preparing an animal litter composition, the method comprising combining particles of a liquid absorbing material with a manganese salt such that the manganese salt at least partially coats, individually, at least a portion of the particles of the liquid absorbing material.

13. The method of claim 12, further comprising combining the particles of the liquid absorbing material including the manganese salt with one or more additives selected from the group consisting of fillers, clumping agents, de-dusting agents, fragrances, bicarbonates, binders, and preservatives.

14. The method of claim 12, further comprising drying the animal litter composition after combination of the particles of the liquid absorbing material with the manganese salt.

15. The method of claim 12, wherein the manganese salt is provided as a solution of the manganese salt in an aqueous solvent.

16. The method of claim 15, wherein the manganese salt is manganese chloride.

17. The method of claim 15, wherein the solution comprises about 0.1% to about 10% manganese salt by weight, based on the total weight of the manganese salt solution.

18. The method of claim 15, wherein the solution is combined with the particles of the liquid absorbing material in a sufficient amount so that the manganese salt is present in the animal litter composition in an amount of at least about 0.005% by dry weight, based on the total dry weight of the coated liquid absorbing material.

19. The method of claim 12, wherein the liquid absorbing material comprises a clay-based material, a non-clay based material, or a combination thereof.

20. The method of claim 12, wherein the manganese salt is combined with the particles of the liquid absorbing material in a sufficient amount to reduce an amount of ammonia gas released from a surface of the animal litter composition by at least about 5% relative to an animal litter of identical composition, but that does not include the manganese salt.
